(19) United States
(12) Patent Application Publication
(10) Pub. No.: US 2015/0021380 A1
(43) Pub. Date: Jan. 22, 2015

(54) Packaging

(71) Applicant: British American Tobacco (Investments Limited, London, LO (GB)

(72) Inventors: Paul Gibson, London (GB); Robert Whiffen, London (GB)

(21) Appl. No.: 14/377,634

(22) PCT Filed: Feb. 13, 2013
(86) PCT No.: PCT/EP2013/052872

§ 371 Date: Aug. 8, 2014

(30) Foreign Application Priority Data
Feb. 13, 2012 (GB) 1202449.3

(51) Int. Cl. B65D 75/68; B31C 99/00; B31C 1/08

(52) U.S. Cl. CPC B65D 75/68; B31C 1/08; B31C 13/00
USPC 229/87.05; 493/287; 493/291; 493/295; 493/208

(57) ABSTRACT

A wrapper (40) comprising a film (41) having a plurality of reinforcing tear strips (42a, 42b) extending at least partially across the film Each tear strip includes a tab portion (45a, 45b). The wrapper (40) is configured such that pulling the tab of a first tear strip causes a tear to propagate through the film (41) to separate a first portion of the film attached to the first tear strip, from the remainder of the film Pulling the tab of a second tear strip causes a second tear to propagate through the film to define a second portion of the film attached to the second tear strip. The second portion of film attached to the second tear strip comprises the remainder of the film once the first portion is removed with the first tear strip. Also, an apparatus and method for manufacturing such a wrapper.

### TECHNICAL FIELD

The present invention relates to packaging and, more particularly, wrappers for packaging and packaging including such wrappers.

### BACKGROUND

Packaging is known which includes a sealed outer wrapper to be removed upon initial opening of the packaging. Such wrappers may include a tear-off strip to aid removal of the wrapper and which separates the wrapper into two portions, at least one of which is to be removed from the pack. The tear strip may remain adhered to one portion of the separated wrapper so that it is removed from the pack, leaving the other portion of the separated wrapper in place over a portion of the pack.

### SUMMARY

In accordance with embodiments of the invention, there is provided a wrapper comprising a film having a plurality of reinforcing tear strips extending at least partially across the film, each tear strip including a tab portion, the wrapper configured such that pulling the tab of a first tear strip causes a tear to propagate through the film to separate a first portion of the film attached to the first tear strip, from the remainder of the film, and pulling the tab of a second tear strip causes a second tear to propagate through the film to define a second portion of the film attached to the second tear strip, wherein the second portion of film attached to the second tear strip comprises the remainder of the film once the first portion is removed with the first tear strip.

The tabs and the first and second tear strips may be configured so that the tear each tear strip causes in the film when the respective tab is pulled, extends in a substantially opposite direction to each other.

The film may comprise a first side and a second, opposite side, and the reinforcing tear strips extends from one of the first and second sides of the film.

The tabs of the first and second tear strips may be located on opposite sides of the film so that the tear each tear strip causes in the film when the respective tab is pulled, extends in a substantially opposite direction to each other.

A line of weakening may be formed in the film between the first and second tear strips.

Each tab portion may be delimited from the respective film edge by an incision.

The tear strips may be adhered to the film.

The invention also provides a package comprising at least one container enveloped in a wrapper as described above. The package may comprise tobacco industry products and/or cigarette packaging.

The invention also provides an apparatus for manufacturing a wrapper for packaging, comprising a supply of film and a supply of reinforcing tear strip material, a pair of rollers through which the film and tear strip material can be fed together to affix two separate portions of tear strip material on the film, and one or more cutting knives configured to form cuts intermittently through the tear strips and the film as the film is conveyed past the cutting knife/knives, wherein the cutting knife/knives are configured to form linear cuts transversely through the film to divide the film into individual wrappers, and to form tab cuts in the tear strips proximate the linear cuts to define a tab portion at one end of each tear strip of each wrapper.

The supply of film may comprise a bobbin of a continuous band of film to be fed through the apparatus.

The supply of tear strip material may comprise one or more bobbins of continuous ribbons of tear strip material to be fed through the apparatus.

The apparatus may further comprise a splicing blade and the continuous ribbon of tear strip material is fed to the splicing blade to be cut into a plurality of tear strips prior to being affixed to the film.

The apparatus may be configured to provide the pair of tear strips in parallel along the film and transversely spaced from each other.

The apparatus may be configured to form the tab cuts extending across the edges of the tear strips into the film adjacent the tear strips.

The apparatus may be configured to form the linear cuts intersecting the tab cuts in the region of the film adjacent the tear strips, but not to extend into the tear strips.

The invention also provides a method of manufacturing a wrapper for packaging comprising applying two separate portions of a reinforcing tear strip material to a film, forming linear cuts transversely through the film to divide the film into individual wrappers, forming tab cuts in the tear strips proximate the linear cuts to define a tab portion at one end of each tear strip of each wrapper.

The method may comprise feeding the supply of film as a continuous band of film from a bobbin.

The method may comprise feeding the portions of tear strip material as continuous ribbons of tear strip material from one or more bobbins.

The method may comprise forming the separate portions of reinforcing tear strip material by feeding a continuous ribbon of tear strip material to a splicing blade and cutting the continuous ribbon of tear strip material using the splicing blade into the plurality of portions of reinforcing tear strip material.

The method may comprise providing the tear strips in parallel along the film and transversely spaced from each other.

The method may comprise forming the tab cuts extending across the edges of the tear strips into the film adjacent the tear strips.

The method may comprise forming the linear cuts intersecting the tab cuts in the region of the film adjacent the tear strips, but not extending into the tear strips.

### BRIEF DESCRIPTION OF THE DRAWINGS

Embodiments of the invention will now be described, by way of example only, with reference to the accompany drawings, in which:

FIG. 1 shows a pack including a wrapper of a first embodiment of the invention partially unwrapped therefrom;

FIG. 2 shows the pack of FIG. 1 with a first tear strip partially removed;

FIG. 3 shows the pack of FIGS. 1 and 2 with the first tear strip and upper portion of the film wrap removed therefrom;

FIG. 4 shows a pack including a wrapper of a second embodiment of the invention including an enlarged view of a portion of the pack;

FIG. 5 shows a schematic drawing of an apparatus for manufacturing a wrapper of the first embodiment of the invention, and enveloping a pack with such a wrapper;

FIG. 6 shows a first view of a portion of the wrapper of the first embodiment of the invention part-way through the manufacturing process;

FIG. 7 shows a second view of a portion of a the wrapper of the first embodiment of the invention part-way through the manufacturing process;

FIG. 8 shows a first cutting roller of the apparatus of FIG. 5; and

FIG. 9 shows a second cutting roller of the apparatus of FIG. 5.

### DETAILED DESCRIPTION

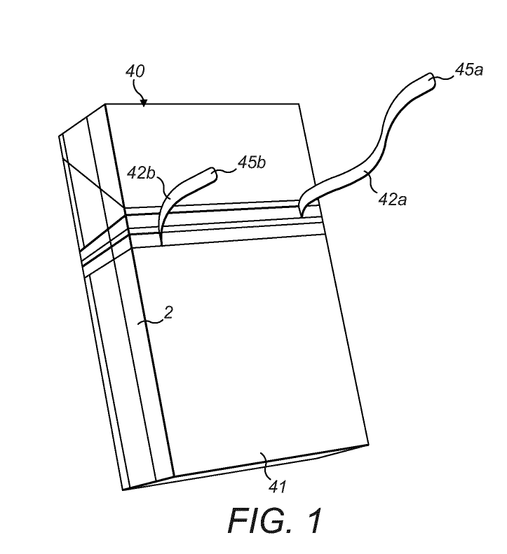

A pack including a wrapper 40 of a first embodiment of the invention is shown in FIG. 1 and comprises a film 41 having first and second sides 43, 44 which overlap at one side wall 2 of the pack 1 and are heat sealed together at the overlap. The film 41 includes two tear strips 42a, 42b, parallel to and spaced a small distance from each other and extending around the perimeter of the pack 1. The two tear strips 42a, 42b are permanently adhered to the film 41, extend from the first side 43 to the second, opposite side 44 of the film 41, and are disposed between the film 41 and the pack 1. The two tear strips 42a, 42b have respective tab portions 45a, 45b at one remote end which are not adhered to the underlying film 41 and are delineated from the surrounding film to which they are attached by cuts around the tab portions 45a, 45b.

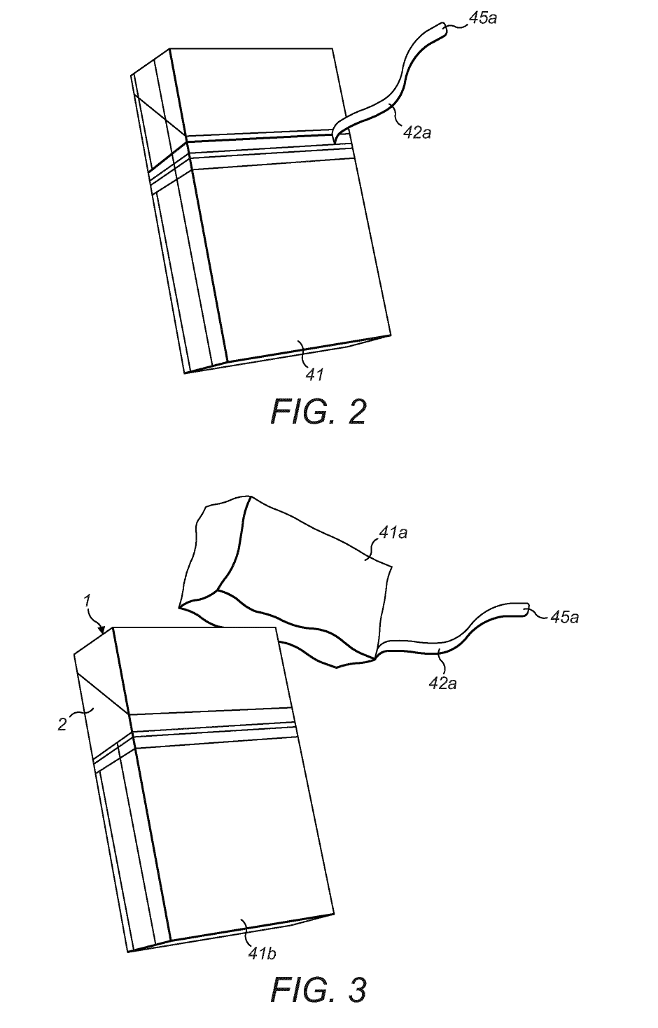

The wrapper 40 must be removed when a user wishes to access the contents of the pack 1. A first part of the removal process is shown in FIGS. 2 and 3. A user pulls the tab portion 45a of the first tear strip 42a which detaches from around the pack 1 (shown in FIG. 2) and tears the film 41 with it, causing the film 41 to separate into an upper portion 41a and a lower portion 41b. Since the first tear strip 42a is permanently adhered to the film 41, the upper portion 41a of the film 41 comes away from the pack 1 with the first tear strip 42a, leaving the lower portion 41b of the film 41 and the second tear strip 42b still on the pack 1 (shown in FIG. 3). The user then pulls the tab portion 45b of the second tear strip 42b away from the pack 1 which initially tears the film 41, and then pulls with it the lower portion 41b of the film 41 away from the pack 1.

The above configuration of wrapper 40 enables the wrapper 40 to be completely, cleanly and efficiently removed from the pack 1 in two parts 41a, 41b using respective tear strips 42a, 42b. In the embodiment shown, the film 41 does not include any lines of weakening between or adjacent the tear strips 42a, 42b to facilitate the tearing of the film 41. This provides a cleaner appearance to the packaging and, in use during wrapper removal, the tear in the film 41 generally propagates from the or each cut surrounding the tab portion 45a, 45b and continues though the film 41 adjacent the tear strip 42a, 42b. However, the invention is not intended to be limited to such an embodiment and the film 41 may alternatively be provided with a line of weakening, such as a stamped, embossed, scored or perforated line, extending between or adjacent the tear strips 42a, 42b to guide the tearing of the film 41 during wrapper removal.

The wrapper 40 of the first embodiment of the invention may also comprise an oriented film to facilitate tearing in a desired direction during the unwrapping process. This is a film which is produced having an internal structure giving it increased strength in a certain direction. An oriented film can tear relatively easily in one direction and such a tear will propagate in a straight line through the film, but the tear will generally not deviate from this line, and the film offers increased resistance to tearing in any other direction. Accordingly, using an oriented film facilitates a tear propagated from a nick or cut following a straight path around the pack perimeter.

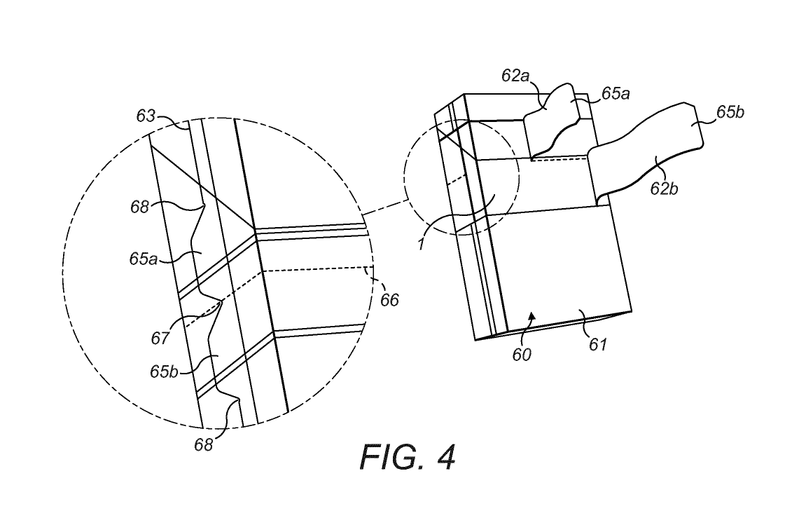

Referring now to FIG. 4, a wrapper 60 of a second embodiment of the invention is shown wrapped around a pack 1 of smoking articles, and is similar to the wrapper 40 of the first embodiment of the invention and likewise comprises a film 61 having two tear strips 62a, 62b, parallel to and spaced a small distance apart from each other and extending around the perimeter of the pack 1, each having respective tab portions 65a, 65b at one remote end thereof which meet at a v-shaped central nick 67. However, the tab portions 65a, 65b are shaped in an edge 63 of the film 61 and are wider than the width of the tear strips 62a, 62b. The edge of the film 63 at the opposite side of each tab 65a, 65b from the central nick 67 includes a further outer nick 68. The film 61 includes a line of weakening 66 extending around the pack 1 between the two tear strips 62a, 62b, extending from the central nick 67, which may be perforations, a score line, or a line of thinner material of the film 61.

Removal of the wrapper 60 from the pack 1 involves pulling the first tab portion 65a away from the pack 1. This causes a tear in the film 61 to propagate from the outer nick 68 of the first tab portion 65a around the pack 1, and also for the film 61 to tear along the line of weakening 66, thereby allowing a strip of film, with the first tear strip 62a attached thereto, to be detached from around the pack 1. An upper portion 61a of the film 61 comes away from the pack 1 with the first tear strip 62a and the attached strip of film 61. The second tab portion 61b is then pulled which causes a tear in the film 61 to propagate from the outer nick 68 of the second tab portion 65b around the pack 1, thereby allowing a strip of film, with the second tear strip 62b attached thereto, to be detached from around the pack, which pulls with it a remaining lower portion 61b of the film 61. As with the first embodiment, the configuration of wrapper 60 of the second embodiment enables the wrapper 60 to be completely, cleanly and efficiently removed from the pack 1 in two parts using respective tear strips 62a, 62b. Also, the film 61 may comprise an oriented film for the same reasons as mentioned above.

In FIGS. 1-4, the wrappers 40, 60 are shown configured such that, when the packs are viewed from above, the tear strips 42a, 42b, 62a, 62b tear around the perimeter of the pack in an anti-clockwise direction, or from left to right across the front (first major face of the pack the tear encounters) of the pack. However, it will be appreciated that the invention is not intended to be limited to this particular configuration and may equally be arranged in an opposite configuration such that the tear strips 42a, 42b, 62a, 62b tear around the perimeter of the pack in a clockwise direction when viewed from above, such that, across the first major face of the pack the tear encounters, the tear proceeds from the right to the left side.

Although embodiments of the invention have been shown and described above in relation to wrappers enveloping a single pack of smoking articles, such wrappers of the invention are intended to be usable as an outer wrapping around alternative configurations of packaging, such as around multiple packs of smoking articles bundled together, either ‘naked’ or in a carton holding, for example, 10 or 20 packs of smoking articles, or around tins or other containers, such as snus containers. Furthermore, such container(s) to be wrapper with wrappers of the invention, do not necessarily need to be parallelepiped in shape, and may comprise other shapes, for example, cylindrical container(s). The various embodiments of the invention are shown and described above as wrappers for packs of smoking articles, or smoking article packaging having various embodiments of outer wrapper. However, the invention is not intended to be limited to such use and it will be appreciated that the invention is equally applicable to wrappers and packaging for any other, non-tobacco industry use.

In the embodiments described above, the wrappers are described as being heat sealed along a seam at an overlap of the wrapper. However, the invention is not intended to be limited to such sealing means, and alternatives are intended within the scope of the invention, such as glue or other adhesive.

In the embodiments described above, the tear tape(s) are described as being adhered to the respective film, although the invention is not intended to be limited to such construction and the tear tape(s) may alternatively be heat sealed to the respective film or comprise other means of sealing thereto. Additionally, although the tear tapes are described as being provided on the inside surface of the wrapper when wrapped around a pack, the tear tapes may equally be provided on the outside of the respective wrapper.

The film and tear strips of the wrappers of the invention described above may be made of a variety of materials, including, but no limited to, polypropylene, polyvinyl chloride (PVC), cellulose acetate film, polyethylene terephthalate (PET), polyethylene oxide (PEOX), polyethylene, cellophane, Natureflex™ or polyactic acid (PLA). Furthermore, combinations of such materials may be used for the film/tear strips respectively. In addition, the film and/or the tear strip material used in the wrappers may be of approximately 200 microns in thickness to approximately 4 microns in thickness.

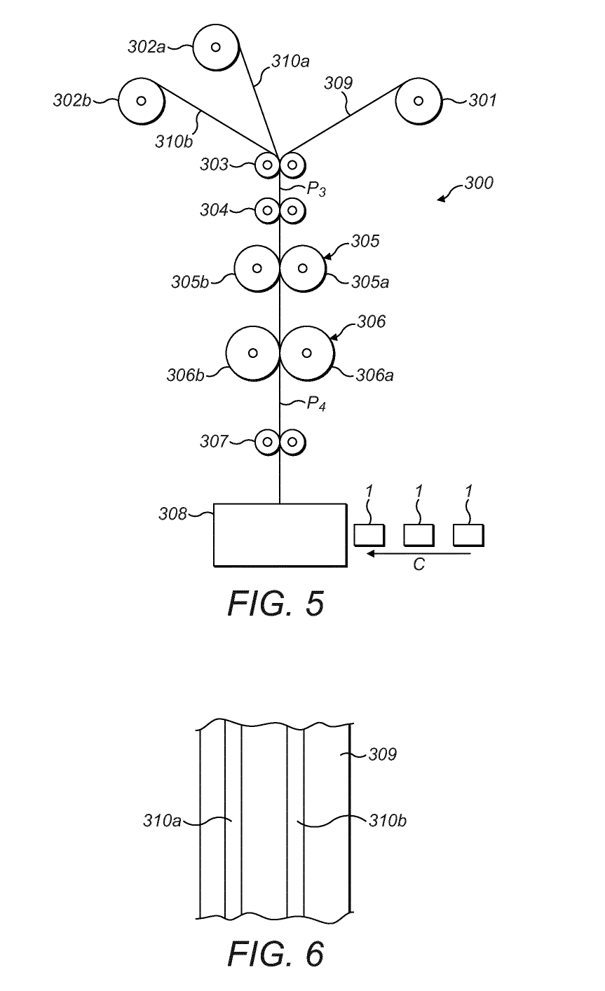

An apparatus 300 for manufacturing a wrapper 40 of the first embodiment of the invention is shown schematically in FIG. 5 and comprises a film bobbin 301, a pair of tape application rollers 303, a first pair of guide rollers 304, a first pair of cutting rollers 305, a second pair of cutting rollers 306, a second pair of guide rollers 307, and a wrapping station 308. Since the wrapper 40 of the first embodiment of the invention comprises two separate tear strips 42a, 42b then the apparatus 300 comprises first and second tape bobbins 302a, 302b.

A continuous band of film 309 is fed from the film bobbin 301, and continuous strips of tear tape 310a, 310b are fed from the first and second tape bobbins 302a, 302b to the tape application rollers 303, where the tear tapes 310a, 310b are applied to the band of film 309. The tear tapes 310a, 310b may have adhesive pre-applied on one side thereof or adhesive may be applied thereto at an adhesive application station (not shown) between the tape bobbins 302a, 30b and the tape application rollers 303.

A view of a section of the continuous film 309 with tear tapes 310a, 310b applied thereto at position P₃ of FIG. 5, is shown in FIG. 6. Here, the spacing of the tear tapes 310a, 310b is exaggerated for the sake of clarity, compared to the spacing of the tear tapes 42a, 42b in FIGS. 1-3.

After passing the tape application rollers 303, the band of film 309 passes through a first pair of guide rollers 304 which control the speed at which the band of film 309 is fed through the apparatus 300.

The band of film 309 then passes through a first pair of cutting rollers 305 comprising a knife roller 305a and a contrast roller 305b. The knife roller 305a, shown in FIG. 8, includes a pair of knife blades 311a, 311b shaped and positioned to form cuts 312 in the tear tapes 310a, 310b and film 309, the knife blades 311a, 311b being configured to form a generally C-shaped cuts.

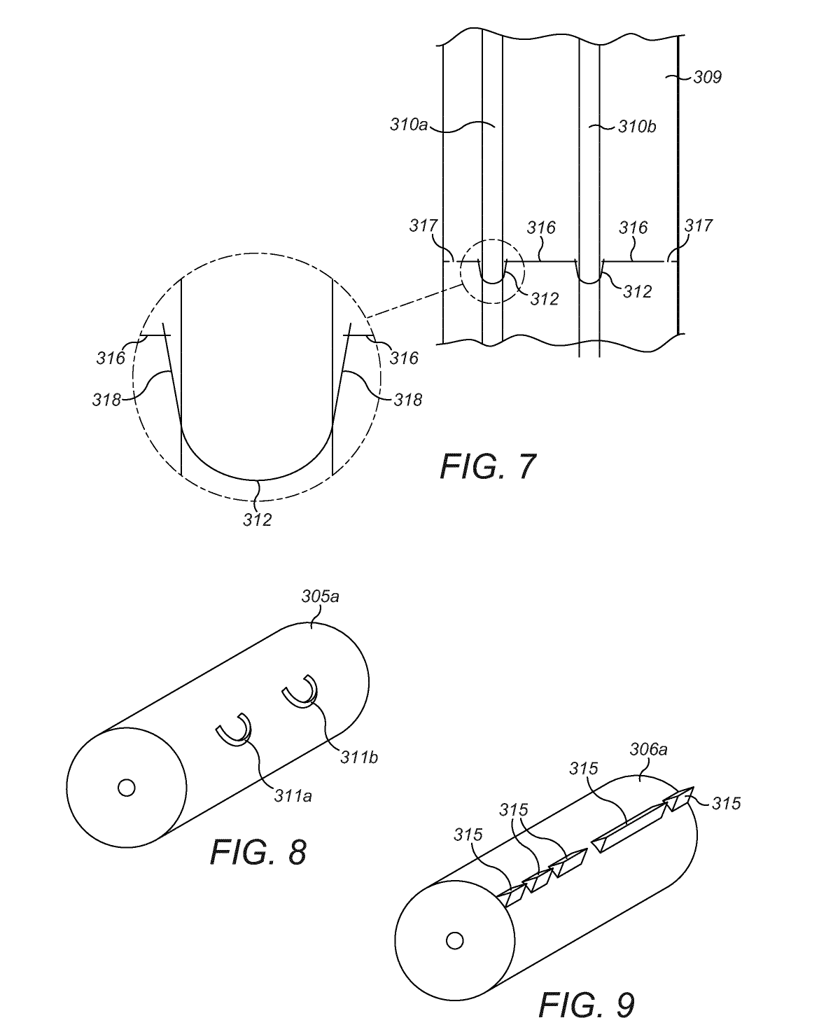

The band of film 309 then passes through the second pair of cutting rollers 306, which includes a knife roller 306a and a contrast roller 306b. The second knife roller 306a is shown in FIG. 9 and includes a series of straight knife blades 315 configured to cut across the band of film 309. The cuts 316 extend across the band of film 309 but small uncut tab regions 317 are left at either side of the band of film 309. Also, the knife blades 315 are configured not to cut across the tab regions 45a, 45b, and the band of film 309 formed after leaving the second pair of cutting rollers 306 (at point P₄ in FIG. 5) is shown in FIG. 7, which shows the band of film 309 for forming the wrapper 40 of the first embodiment of the invention shown in FIGS. 1-3. Referring to the ‘C’ shaped cut 312 formed in the wrapper 40, the linear cuts 316 cross the tails 318 of the ‘C’ cut in the film 309 to ensure a clean separation of the tabs 45a, 45b of the tear strips 42a, 42b from the preceding wrapper 40, but the linear cuts 316 do not extend as far as the tear strips 310a, 310b so as to avoid weakening the tabs 45a, 45b or tear strips 42a, 42b of the finished wrapper 40.

After the cut band of film 309 exits the second pair of cutting roller 306, it passes through a further pair of guide rollers 307 to be fed into a wrapping station 308 where a succession of packs of smoking articles 1 are fed in the direction of arrow C, each one plunging into the mid point of the end-most wrapper 40, which causes the tab regions 317 to sever, separating the wrapper 40 from the band of film 309 and the pack 1 is then wrapped and sealed with the wrapper 40.

Although the second knife roller 306a is configured to leave uncut tab regions 317 proximate the edges of the band of film 309, the invention is not limited to this configuration and the linear cuts 316 may extend entirely to the edges of the band of film 309 to fully separate individual wrappers 40 from each other prior to the pack wrapping stage.

Although the cuts are described as being formed in the band of film 309 by pairs of cutting rollers 305, 306, the invention is not limited to this particular embodiment and instead, the band of film 309 may pass between a knife mounted on a cam, and a bearing or roller, such that the knife reciprocates to form the desired cuts intermittently along the passing band of film 309. In such an embodiment, the knife may be mounted on a plate to stamp the cuts into the film.

Instead of the respective tear tapes 310a, 310b being fed from separate bobbins 302a, 302b, multiple tear tapes could alternatively be supplied from a single bobbin. Furthermore, a single wide strip of tear tape material could be fed to a splicing roller or other splicing means, which could cut the tear tape material lengthwise into the desired number of tear tapes, which could subsequently be fed to the film to be adhered thereto.

As used herein, the term “smoking article” includes smokeable products such as cigarettes, cigars and cigarillos whether based on tobacco, tobacco derivatives, expanded tobacco, reconstituted tobacco or tobacco substitutes and also heat-not-burn products. The smoking article may be provided with a filter for the gaseous flow drawn by the smoker.

A tobacco industry product refers to any item made in, or sold by the tobacco industry, typically including a) cigarettes, cigarillos, cigars, tobacco for pipes or for roll-your-own cigarettes, (whether based on tobacco, tobacco derivatives, expanded tobacco, reconstituted tobacco or tobacco substitutes); b) non-smoking products incorporating tobacco, tobacco derivatives, expanded tobacco, reconstituted tobacco or tobacco substitutes such as snuff, snus, hard tobacco, and heat-not-burn products; and c) other nicotine-delivery systems such as inhalers, lozenges and gum. This list is not intended to be exclusive, but merely illustrates a range of products which are made and sold in the tobacco industry.

In order to address various issues and advance the art, the entirety of this disclosure shows by way of illustration various embodiments in which the claimed invention(s) may be practiced and provide for superior packaging wrappers. The advantages and features of the disclosure are of a representative sample of embodiments only, and are not exhaustive and/or exclusive. They are presented only to assist in understanding and teach the claimed principles. It should be understood that they are not representative of all claimed inventions. As such, certain aspects of the disclosure have not been discussed herein. That alternate embodiments may not have been presented for a specific portion of the invention or that further un-described alternate embodiments may be available for a portion is not to be considered a disclaimer of those alternate embodiments. It will be appreciated that many of those un-described embodiments incorporate the same principles of the invention and others are equivalent. Thus, it is to be understood that other embodiments may be utilized and modifications may be made without departing from the scope and/or spirit of the disclosure. As such, all examples, implementations, and/or embodiments are deemed to be non-limiting throughout this disclosure. Also, no inference should be drawn regarding those embodiments discussed herein relative to those not discussed herein other than it is as such for purposes of reducing space and repetition. Various embodiments may suitably comprise, consist of, or consist essentially of, various combinations of the disclosed elements, components, features, parts, steps, means, etc. Some of the disclosed features, elements, implementation, etc., may be mutually contradictory, in that they cannot be simultaneously present in a single embodiment. Similarly, some features are applicable to one aspect of the disclosure, and inapplicable to others. In addition, the disclosure includes other inventions not presently claimed. Applicant reserves all rights in those presently unclaimed inventions including the right to claim such inventions, file additional applications, continuations, continuations in part, divisions, and/or the like thereof. As such, it should be understood that advantages, embodiments, examples, function, features, structural, and/or other aspects of the disclosure are not to be considered limitations on the disclosure as defined by the claims or limitations on equivalents to the claims.

1. A wrapper comprising
a film having a plurality of reinforcing tear strips extending at least partially across the film,
each tear strip including a tab portion,
the wrapper configured such that pulling the tab of a first tear strip causes a tear to propagate through the film to separate a first portion of the film attached to the first tear strip, from the remainder of the film, and pulling the tab of a second tear strip causes a second tear to propagate through the film to define a second portion of the film attached to the second tear strip,
wherein the second portion of film attached to the second tear strip comprises the remainder of the film once the first portion is removed with the first tear strip.

2. A wrapper according to claim 1 wherein the tabs and the first and second tear strips are configured so that the tear each tear strip causes in the film when the respective tab is pulled, extends in a substantially opposite direction to each other.

3. A wrapper according to claim 1 wherein the film comprises a first side and a second, opposite side, and the reinforcing tear strips extends from one of the first and second sides of the film.

4. A wrapper according to claim 3 wherein the tabs of the first and second tear strips are located on opposite sides of the film so that the tear each tear strip causes in the film when the respective tab is pulled, extends in a substantially opposite direction to each other.

5. A wrapper according to claim 1 wherein a line of weakening is formed in the film between the first and second tear strips.

6. A wrapper according to claim 1 wherein each tab portion is delimited from the respective film edge by an incision.

7. A wrapper according to claim 1 wherein the tear strips are adhered to the film.

8. A wrapper of claim 1 further having a package comprising at least one container enveloped in the wrapper.

9. A wrapper of claim 8 wherein the package according to claim g comprising tobacco industry products and/or cigarette packaging.

10. An apparatus for manufacturing a wrapper for packaging, comprising
a supply of film and a supply of reinforcing tear strip material,
a pair of rollers through which the film and tear strip material can be fed together to affix two separate portions of tear strip material on the film, and
one or more cutting knives configured to form cuts intermittently through the tear strips and the film as the film is conveyed past the cutting knife/knives,
wherein the cutting knife/knives are configured to form linear cuts transversely through the film to divide the film into individual wrappers, and to form tab cuts in the tear strips proximate the linear cuts to define a tab portion at one end of each tear strip of each wrapper.

11. An apparatus according to claim 10 wherein the supply of film comprises a bobbin of a continuous band of film to be fed through the apparatus.

12. An apparatus according to claim 10 wherein the supply of tear strip material comprises one or more bobbins of continuous ribbons of tear strip material to be fed through the apparatus.

13. An apparatus according to claim 12 further comprising a splicing blade and the continuous ribbon of tear strip material is fed to the splicing blade to be cut into a plurality of tear strips prior to being affixed to the film.

14. An apparatus according to claim 12 configured to provide the pair of tear strips in parallel along the film and transversely spaced from each other.

15. An apparatus according to claim 10 configured to form the tab cuts extending across the edges of the tear strips into the film adjacent the tear strips.

16. An apparatus according to claim 15 configured to form the linear cuts intersecting the tab cuts in the region of the film adjacent the tear strips, but not to extend into the tear strips.

17. A method of manufacturing a wrapper for packaging comprising
applying two separate portions of a reinforcing tear strip material to a film,
forming linear cuts transversely through the film to divide the film into individual wrappers,
forming tab cuts in the tear strips proximate the linear cuts to define a tab portion at one end of each tear strip of each wrapper.

18. A method according to claim 17 comprising feeding the supply of film as a continuous band of film from a bobbin.

19. A method according to claim 17 comprising feeding the portions of tear strip material as continuous ribbons of tear strip material from one or more bobbins.

20. A method according to claim 19 comprising forming the separate portions of reinforcing tear strip material by feeding a continuous ribbon of tear strip material to a splicing blade and cutting the continuous ribbon of tear strip material using the splicing blade into the plurality of portions of reinforcing tear strip material.

21. A method according to claim 19 comprising providing the tear strips in parallel along the film and transversely spaced from each other.

22. A method according to any of claims 17 comprising forming the tab cuts extending across the edges of the tear strips into the film adjacent the tear strips.

23. A method according to claim 22 comprising forming the linear cuts intersecting the tab cuts in the region of the film adjacent the tear strips, but not extending into the tear strips.
